(19) United States
(12) Patent Application Publication
(10) Pub. No.: US 2010/0225499 A1
(43) Pub. Date: Sep. 9, 2010

(54) DEVICE FOR INPUTTING CONTROL COMMANDS

(75) Inventors: Beng Tee Peh, Singapore (SG); Hwai Kiang Tan, Singapore (SG); Chee Wee Tay, Singapore (SG); Keong Huat Sim, Singapore (SG)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/161,824

(22) PCT Filed: Jan. 16, 2007
(86) PCT No.: PCT/IB07/50127

§ 371 Date: Jul. 23, 2008

(30) Foreign Application Priority Data
Jan. 27, 2006 (EP) 06100963.5

(51) Int. Cl. G08B 7/06; H04L 17/02

(52) U.S. Cl. 340/815.69

(57) ABSTRACT

A device for inputting control commands has an at least in parts light-transmitting surface and includes an apparatus for projecting a number of graphic symbols through respective symbol areas (3,4) of the surface, a control command being associated with each graphic symbol. The apparatus includes a lighting arrangement (10;16;22) for selectively illuminating symbol areas (3,4) from within the device through at least one screen (12;17;24) patterned simultaneously in accordance with a plurality of the graphic symbols. The at least in parts light-transmitting surface includes at least one area (2) corresponding to a key, each area (2) corresponding to a key encompassing at least one of the symbol areas (3,4). The device for inputting control commands further includes an input device (13;20;25) for detecting selection of an area (2) corresponding to a key by a body. The device includes at least one sheet (14;19;26) arranged to allow at least partial transmission of light from the arrangement for selectively illuminating symbol areas (3,4) to the surface and arranged to decrease a contrast between graphic symbols and surrounding parts of at least symbol areas (3,4) other than those being illuminated.

The invention relates to a device for inputting control commands,

having an at least in parts light-transmitting surface and including

an apparatus for projecting a number of graphic symbols through respective symbol areas of the surface, a control command being associated with each graphic symbol, which apparatus includes

a lighting arrangement for selectively illuminating symbol areas from within the device through at least one screen patterned simultaneously in accordance with a plurality of the graphic symbols,

wherein the at least in parts light-transmitting surface includes at least one area corresponding to a key, each area corresponding to a key encompassing at least one of the symbol areas, wherein the device for inputting control commands further includes an input device for detecting selection of an area corresponding to a key by a body.

The invention also relates to a method of obtaining control commands, including

providing a device having an at least in parts light-transmitting surface and including an apparatus for projecting a number of graphic symbols through respective symbol areas of the surface, which apparatus includes

a lighting arrangement for selectively illuminating symbol areas from within the device through at least one screen patterned in accordance with a plurality of the graphic symbols,

wherein the at least in parts light-transmitting surface includes at least one area corresponding to a key, each area corresponding to a key encompassing at least one of the symbol areas, which method includes

associating a control command with each graphic symbol, and

selectively illuminating a sub-set of the symbol areas in accordance with a mode of operation of a device being controlled, so as to project associated graphic symbols through the respective symbol areas,

wherein a control command is obtained by detecting selection of an area corresponding to a key by a body.

The invention also relates to an electronic appliance, including a device having an at least in parts light-transmitting surface and including an apparatus for projecting a number of graphic symbols through respective symbol areas of the surface, which apparatus includes

a lighting arrangement for selectively illuminating symbol areas from within the device through at least one screen patterned in accordance with a plurality of the graphic symbols,

wherein the at least in parts light-transmitting surface includes at least one area corresponding to a key, each area corresponding to a key encompassing at least one of the symbol areas.

An example of such a device, method and appliance is known. Multi-segmented electroluminescence remote controls work by only lighting up segments of keys that are used with a selected mode of the device for which the control commands are intended. In this way, a (in this case physical) key can have more than one function, but only the function in the selected mode will be illuminated by the segmented electroluminescence. This reduces the clutter on the remote control by lighting up key segments that are used in that mode. However, due to the properties of electroluminescence foil, when a key segment is lit up, the neighbouring key segment can still be seen. This can be described as a “spillover” effect.

It is an object of the invention to provide a device, method and appliance of the types described above that allow easy presentation of different sub-sets of available commands to a user in different modes and decrease the likelihood of selection of an area of a key encompassing a graphic symbol that is associated with a control command not available in the current mode.

This object is achieved by the device according to the invention which is characterised by including at least one sheet arranged to allow at least partial transmission of light from the arrangement for selectively illuminating symbol areas to the surface and arranged to decrease a contrast between graphic symbols and surrounding parts of at least symbol areas other than those being illuminated.

Because the device includes a lighting arrangement for selectively illuminating symbol areas from within the device through at least one screen patterned simultaneously in accordance with a plurality of the graphic symbols, selection of a sub-set of available commands is relatively easy. All that is required is to switch the illuminated symbol areas. The patterning is present at least when selected symbol areas are illuminated. Because the device includes at least one sheet arranged to allow at least partial transmission of light from the arrangement for selectively illuminating symbol areas to the surface and arranged to decrease a contrast between graphic symbols and surrounding parts of at least symbol areas other than those being illuminated, the graphic symbols in the non-illuminated symbol areas are obscured when the control commands associated with them are not available. The “spillover” effect is reduced by means of the sheet arranged to decrease the contrast between graphic symbols and surrounding parts of at least the non-illuminated symbol areas, so that other sources of light than those arranged to illuminate those areas directly are less likely to cause the graphic symbols to become intelligible. Easy switching between modes is enhanced since the screen patterned in accordance with a plurality of the graphic symbols in one mode need not be re-patterned immediately to switch to another mode.

It is observed that JP-2002-247674 discloses a display device for a remote controller. The display section is configured by layering a half mirror, an information display liquid crystal display panel and a lighting switching light source in this order. The lighting switching light source lights up the information display liquid crystal display panel to make a user view liquid crystal indication on the half mirror, so that the display panel of the half mirror can be used for a mirror surface by turning off the lighting by the lighting switching light source in a non-display state, when an operating state and a setting state are not displayed. As a result, the display panel, when no information is displayed, is made to have a desirable external appearance and the display face can be used for the mirror surface. A display condition change means is a means which changes a display condition and a non-display condition based on change of a part of electrostatic capacity of the front face of the display means.

This known device does not include a lighting arrangement for selectively illuminating symbol areas from within the device through at least one screen patterned in accordance with a plurality of the graphic symbols. Instead, the lighting switching light source functions as a backlight for the entire LCD panel. Also, the known device does not include an apparatus for projecting a number of graphic symbols, a control command being associated with each graphic symbol. Instead, only one control command is associated with an area corresponding to the entire surface, which is the command to switch illumination mode between entirely off and entirely on.

In an embodiment, at least one area corresponding to a key encompasses multiple symbol areas.

The effect is that the available surface area is put to better use, with a larger available surface area corresponding to the key. One of several different commands can be input with the same key, in dependence on the mode of operation. Confusion as to which command pertains in the current mode is avoided because it is possible to project the graphic symbol associated with the pertinent command much more strongly relative to the symbols of the other symbol areas encompassed by the area corresponding to the key.

In an embodiment, the lighting arrangement includes a plurality of light-emitting diodes positioned behind the screen and under the symbol areas as seen from the surface of the device.

The effect is that the symbol areas are illuminated more strongly as opposed to variants in which illumination is from the sides of the surface. Different symbol can also be lighted with different colour of LED, thereby enhancing the visual differences of each function. A further effect is that there is little spillover of light to symbol areas adjacent those selected for illumination. Another effect is that relatively fast switching between modes with different symbol areas selected for illumination is possible compared with, for example, electroluminescent lighting arrangements.

In an embodiment, the screen comprises at least one liquid crystal display panel, preferably a negatively polarised liquid crystal display panel.

The effect is that the graphic symbols are configurable by directing control signals to the liquid crystal display (LCD) panel. The use of such an LCD panel in combination with a sheet arranged to decrease a contrast between graphic symbols and surrounding parts of at least symbol areas other than those being illuminated, means that the graphic symbols that are being projected contrast strongly with their environment. This enhances the visibility of the graphic symbols even where a low level of backlighting is used.

In an embodiment, the screen includes a reverse-printed diffuser plate.

The effect is to allow relatively cheap manufacturing and relatively simple control of the device for inputting control commands. The diffuser plate ensures that the graphic symbol is projected with a relatively uniform intensity.

In an embodiment, the lighting arrangement includes a mechanical partition placed over an array of light sources and located behind the at least one screen as seen from the surface of the device.

This embodiment has the advantage that there is substantially no spillover of light for illuminating selected symbol areas to non-selected symbol areas. The sheet arranged to allow at least partial transmission of light from the arrangement for selectively illuminating symbol areas to the surface and arranged to decrease a contrast between graphic symbols and surrounding parts of at least symbol areas other than those being illuminated ensures that light from other sources, for example external to the input device, does not unintentionally light up a graphic symbol.

In an embodiment, the lighting arrangement includes at least one source of coloured light and the sheet for decreasing contrast includes a colour filter.

The effect is that light other than that from the source of coloured light can be blocked, so that illumination by the source determines how clearly the graphic symbols are visible.

In an embodiment, the sheet for decreasing contrast includes a layer for reflecting light away from the surface of the device, positioned over the screen to the side of the surface of the device.

The effect is to obscure non-illuminated graphic symbols, because any light falling on the corresponding symbol area will be relatively weak compared to the reflected light. Thus, the contrast of the symbol relative to the immediately surrounding area is reduced.

According to another aspect, the method of obtaining control commands according to the invention is characterised by obscuring at least the graphic symbols projected through at least one of the symbol areas other than those being illuminated.

The effect is that it is possible to provide a device with a number of pre-configured graphic symbols, each associated with a control command, but that only those valid in a prevailing mode of operation are clearly visible. Thus, inadvertent selection of key area encompassing a surface area through which such a graphic symbol could be projected is made less likely.

An embodiment of the method includes the use of a device according to the invention.

According to another aspect, the electronic appliance according to the invention is configured to execute a method according to the invention.

The invention will now be explained in further detail with reference to the accompanying drawings, in which:

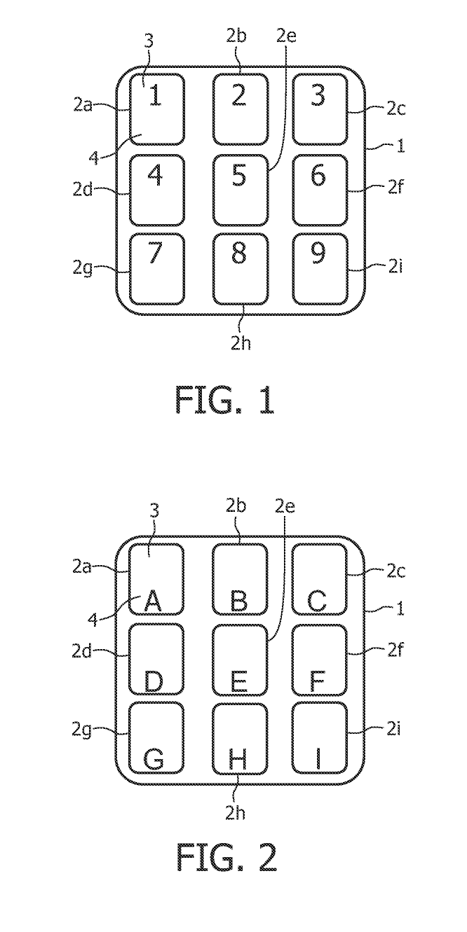

FIG. 1 is a top plan view of a surface of an input device in a first mode;

FIG. 2 is a top plan view of a surface of an input device in a second mode;

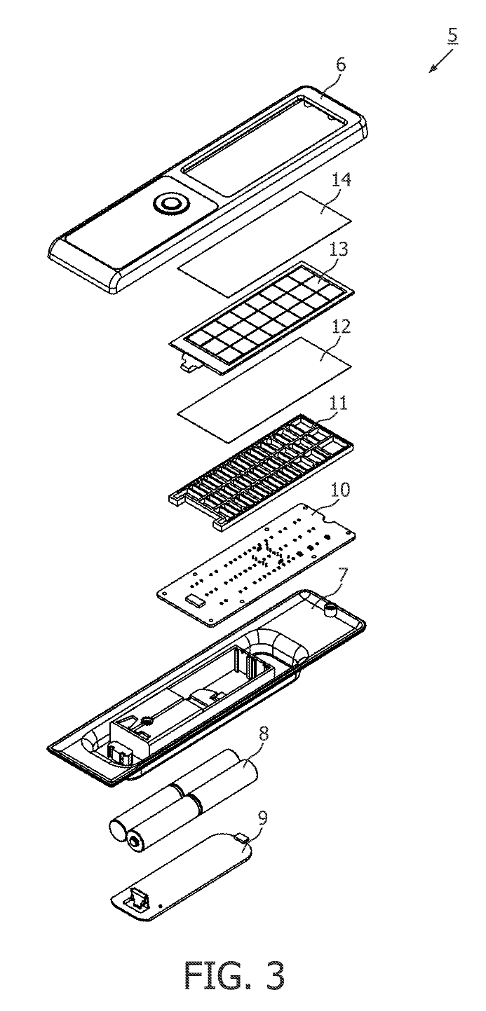

FIG. 3 is an exploded perspective view of a remote control device comprising an input device that includes a filter sheet;

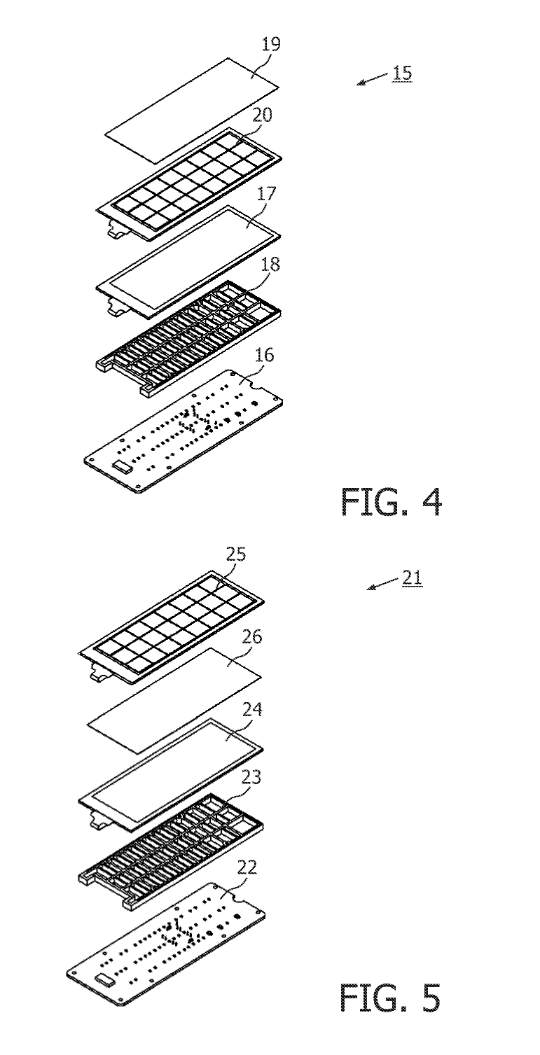

FIG. 4 is an exploded perspective view of an apparatus for projecting graphic symbols through a surface of a remote control device, comprising a mirror film; and

FIG. 5 is an exploded perspective view of an alternative apparatus for projecting graphic symbols through a surface of a remote control device, comprising a mirror film.

An interface area 1 of an input device as exemplified in FIGS. 1 and 2 includes nine keys 2a-2i. The surface of a first key 2a includes a first section 3 and a second section 4. The remaining keys 2b-2i can similarly be thought of as partitioned into at least two sections, which are not referred to separately in order to improve the intelligibility of the drawings.

At least parts of the area of each key 2 are configured to allow light to emanate from the device. These parts include parts of the first and second sections 3,4, through which graphic symbols can be projected. In the embodiment illustrated in FIGS. 1 and 2, a numeral “1” can be projected through the first section of the surface of the first key 2a, and a letter “A” can be projected through the second section 4 of the surface of the first key 2a. These sections 3,4 correspond to symbol areas.

The input device illustrated in FIG. 1,2 has two modes, depicted in FIGS. 1 and 2, respectively. The numerals are projected through the associated sections of the surfaces of the keys 2 in a first mode. The letters are projected through the associated sections of the surfaces of the keys 2 in a second mode.

A control command is associated with each graphic symbol, i.e. each letter and numeral. However, not all control commands are accessible in a single mode. In the first mode, selection of an area corresponding to a key by a body, if detected, leads to registration of the control command associated with the numeral on the key. In the second mode, the command associated with the letter is registered, meaning that a signal corresponding to that control command (a character code in this case) is provided to an interface to the electronic appliance (not shown) being controlled.

An input device is provided that detects selection of one of the several areas corresponding to the respective keys 2 by a body. In some embodiments, a body in the shape of a special type of pointing device is required. In other embodiments a body in the form of a user's finger is required. The input device can be any of a device that detects the presence of the body at a certain proximity to the area corresponding to a key 2, a device that detects pressure exerted through the area corresponding to a key and exceeding a certain threshold, or a device that is merely sensitive to touch. In any event, the input device is at the surface of the device for inputting control commands and configured so as not to hinder the projection of graphic symbols associated with available control commands through the surface. Examples include a transparent (mechanical) keyboard made of rubber or rubber with a plastic cover layer, as well as touch screens that use capacitance changes, surface acoustical waves, changes in resistance of pressure-sensitive resistors, or interruption in infra-red light fields to detect whether an area corresponding to a key 2 is being selected, and which one this is. In an alternative embodiment, a polydome, PET or Mylar foil is used for the input device.

As illustrated in FIGS. 1 and 2, in each of the first and second mode, a sub-set of the symbol areas are selectively illuminated, whilst at least the symbol areas other than those in the sub-set are obscured. In the illustrated embodiments, a means for decreasing the contrast between graphic symbols and surrounding parts of the symbol areas in which they are located is chosen that is applied to all the symbol areas. The means are configured such that the extent to which the graphic symbols in the illuminated symbol areas are obscured is insufficient for reducing the contrast to a level at which the illuminated graphic symbols would be invisible. Thus, only the selective illumination determines which graphic symbols are visible. The level of selective illumination exceeds the brightness of ambient or stray light to such an extent that the means for obscuring projected graphic symbols only obscure the non-illuminated graphic symbols.

Two basic types of means for obscuring are discussed herein by way of example. A first type is exemplified by the embodiment illustrated in FIG. 3. A second type is exemplified by the embodiments of FIGS. 4 and 5.

FIG. 3 provides an exploded view of an embodiment of a type of device for inputting control commands, in the illustrated example, a hand-held remote control device 5. The construction is also applicable to interfaces to electronic appliances that are mounted directly to the appliance to be controlled. The remote control device 5 comprises a housing comprising an upper half 6 and a lower half 7, and a compartment for batteries 8, covered by a lid 9.

A printed circuit board (PCB) assembly 10 includes control electronics and an array of LEDs (not shown in detail). The LEDs are driven by ports available in an integrated circuit or driven in matrix style in a manner similar to that of a remote control key matrix. The LEDs are powered by means of electrical pulses having an appropriate duty cycle, in order to prolong the useful lifetime of the batteries 8.

Light emitted by the LEDs of the PCB assembly 10 is partitioned by a mechanical partition 11. The partition 11 is covered by a diffuser plate 12, which is patterned in accordance with graphic symbols to be projected by illumination by the LEDs of the PCB assembly 10.

In one embodiment, there is a single LED for each compartment in the partition 11, which LED is arranged to emit light of a single colour. In another embodiment, there is a plurality of LEDs in each compartment, with each LED arranged to emit light of a single colour, which differs per LED. In yet another embodiment, there are one or more bi-colour LEDs for each compartment, or even tri-colour LEDs.

The diffuser plate 12 is added to create lighted text or graphics. The graphic symbols to be projected, are reverse-printed on the diffuser plate 12, to create even brightness of light. The graphic symbols are located in symbol areas placed over only one of the compartments of the partition 11. As explained above, there is an independent source of light for each compartment, so that the associated symbol areas can be selectively illuminated. The partition 11 confines the light to the symbol areas aligned with the compartment. Graphic symbols over compartments with none of the LEDs turned on are not projected. In one embodiment, there is only one graphic symbol for each compartment. In another embodiment, the area encompassed by a compartment corresponds to a key, which may encompass multiple symbol areas.

In certain embodiments, the diffuser plate 12 is arranged to decrease a contrast between graphic symbols and surrounding parts of at least symbol areas other than those being illuminated. In these embodiments, the graphic symbols are printed in different colours, in dependence on the source of light illuminating the symbol areas in which they lie. Alternatively, the diffuser plate 12 itself functions as a colour-selective filter of light.

The remote control device 5 further includes a touch panel 13, of any of the types mentioned above in the general discussion having regard to FIGS. 1 and 2. The touch panel 13 is used to detect selection of an area corresponding to a key by a body manipulated by the user, or indeed a finger or other part of the body of the user.

A filter sheet 14 is used to conceal the visibility of graphic symbols, as well as providing the required contrast of the symbols in symbol areas that are being illuminated. To this end, the filter sheet 14 is implemented as a colour filter, and arranged to pass predominantly light of the colour of the source of illumination. Even where all the LEDs of the PCB assembly are arranged to emit light of the same colour, this still has the effect that ambient light cannot cause the non-illuminated graphic symbols to become visible. Also, structural features of the touch panel 13 are hidden from view under ambient light.

The filter sheet 14 can be arranged to impart other desirable properties to the remote control device 5, such as scratch-resistance or a particular colour or texture to reduce smudges and fingerprints. The filter sheet 14 represents a first type of sheet arranged to decrease a contrast between graphic symbols and surrounding parts of at least symbol areas other than those being illuminated, whilst allowing at least partial transmission of light from the arrangement for selectively illuminating symbol areas.

A second type of sheet is exemplified by the embodiments shown in FIGS. 4 and 5.

In FIG. 4, an apparatus 15 for projecting a number of graphic symbols through respective symbol areas of an at least in parts light-transmitting surface of an input device is shown. The apparatus 15 is suitable for mounting between upper and lower halves of a remote control housing, such as that of the remote control device 5 shown in FIG. 3.

The embodiment of FIG. 4 comprises an array of light-emitting diodes (not shown in detail), mounted on a printed circuit board (PCB) assembly 16, which further includes control electronics. The LEDs can be of the organic or inorganic variety. The PCB assembly is positioned behind a Liquid Crystal Display (LCD) screen 17, separated by a mechanical partition 18. The partition 18 confines the light to the symbol area or areas aligned with the compartment. The effect of positioning the LEDs directly behind the LCD screen 17 is that relatively little attenuation of light can occur, and that relatively little light can spill over to areas of the LCD screen that are not selected for illumination in a particular mode. This is particularly the case compared to conventional backlights, which tend to illuminate LCD screens from one or more of the edges. In the illustrated embodiment, one or more areas of the LCD screen 17, corresponding to symbol areas, can be illuminated selectively.

The LCD screen 17 is configured for patterning of areas corresponding to symbol areas, which patterning is in accordance with a graphic symbol to be projected through the associated symbol area. In the contemplated embodiment, the LCD screen 17 is a negatively polarised LCD screen 17, meaning that it is ordinarily not in a light-transmitting state, but that selected pixels can be made transparent by application of control signals.

To obscure the graphic symbols that are patterned on the LCD screen 17 but not illuminated in a particular mode, a mirror film 19 is provided on the outer surface of the touch panel. The mirror film 19 is transparent to light projected through the LCD screen 17, at least within a range of the visible spectrum of light within which the LEDs are operative. The mirror film reflects light away from the surface of the device for inputting control commands. The effect is that ambient light obscures light projected through all symbol areas except those illuminated by the LEDs. When no symbol areas are illuminated, a high-gloss finish is presented to the user. The mirror film 19 also has the effect of reducing the visibility of spacers and Indium Tin Oxide (ITO) layers patterns in a touch panel 20. Conventional techniques for reducing the visibility of these components are more costly in terms of their use of materials.

In the embodiment shown in FIG. 4, the mirror film 19 is positioned over the touch panel 20, which may be of any of the types discussed above. FIG. 5 shows an alternative apparatus 21 for projecting graphic symbols through a surface of an input device. It, too, comprises a PCB assembly 22, a partition 23, an LCD screen 24 and a touch panel 25 and mirror film 26. These parts correspond in construction to the corresponding parts of the apparatus 15 shown in FIG. 4. The apparatus 21 of FIG. 5 differs in that the mirror film 26 is provided over the LCD screen 24 and under the touch panel 25, looking at the surface of the input device through which, in use, the graphic symbols are projected.

The remote control device 5, and those comprising the alternative apparatuses 15, 21 of FIGS. 4 and 5, is, like all the devices for inputting control commands discussed above, suitable for controlling the operation of electrical appliances such as set-top boxes, video cassette recorders, home theatres, DVD players, CD players, satellite tuners, game consoles, heating ventilation and air-conditioning equipment, home lighting appliances, automatic draperies, etc.

It should be noted that the above-mentioned embodiments illustrate, rather than limit, the invention, and that those skilled in the art will be able to design many alternative embodiments without departing from the scope of the appended claims. In the claims, any reference signs placed between parentheses shall not be construed as limiting the claim. The word “comprising” does not exclude the presence of elements or steps other than those listed in a claim. The word “a” or “an” preceding an element does not exclude the presence of a plurality of such elements. The mere fact that certain measures are recited in mutually different dependent claims does not indicate that a combination of these measures cannot be used to advantage.

For example, certain embodiments may, instead of, or in addition to, LEDs, include one or more other sources of light. However, LEDs have the advantage of allowing a blinking projection of graphic symbols at a relatively high frequency compared to other, inherently less responsive, types of light sources. Also, LEDs are relatively silent in operation.

1. Device for inputting control commands,
having an at least in parts light-transmitting surface and including
an apparatus for projecting a number of graphic symbols through respective symbol areas (3,4) of the surface, a control command being associated with each graphic symbol, which apparatus includes
a lighting arrangement (10;16;22) for selectively illuminating symbol areas (3,4) from within the device through at least one screen (12;17;24) patterned simultaneously in accordance with a plurality of the graphic symbols,
wherein the at least in parts light-transmitting surface includes at least one area (2) corresponding to a key, each area (2) corresponding to a key encompassing at least one of the symbol areas (3,4), wherein the device for inputting control commands further includes an input device (13,20,25) for detecting selection of an area (2) corresponding to a key by a body, characterised by
including at least one sheet (14;19;26) arranged to allow at least partial transmission of light from the arrangement for selectively illuminating symbol areas (3,4) to the surface and arranged to decrease a contrast between graphic symbols and surrounding parts of at least symbol areas (3,4) other than those being illuminated.

2. Device according to claim 1, wherein at least one area (2a) corresponding to a key encompasses multiple symbol areas (3,4).

3. Device according to claim 1, wherein the lighting arrangement includes a plurality of light-emitting diodes positioned behind the screen (12;17;24) and under the symbol areas (3,4) as seen from the surface of the device.

4. Device according to claim 1, wherein the screen (17;24) comprises at least one liquid crystal display panel, preferably a negatively polarised liquid crystal display panel.

5. Device according to claim 1, wherein the screen (12) includes a reverse-printed diffuser plate.

6. Device according to claim 1, wherein the lighting arrangement includes a mechanical partition (11;18;23) placed over an array of light sources and located behind the at least one screen (12;17;24) as seen from the surface of the device.

7. Device according to claim 1, wherein the lighting arrangement (10) includes at least one source of coloured light and at least one of the sheets (14) for decreasing contrast includes a colour filter.

8. Device according to claim 1, wherein at least one of the sheets (19;26) for decreasing contrast includes a layer for reflecting light away from the surface of the device, positioned over the screen (17;24) to the side of the surface of the device.

9. Method of obtaining control commands, including
providing a device (5) having an at least in parts light-transmitting surface (1) and including an apparatus for projecting a number of graphic symbols through respective symbol areas (3,4) of the surface, which apparatus includes
a lighting arrangement (10;16;22) for selectively illuminating symbol areas from within the device through at least one screen (12;17;24) patterned in accordance with a plurality of the graphic symbols,
wherein the at least in parts light-transmitting surface includes at least one area (2) corresponding to a key, each area (2) corresponding to a key encompassing at least one of the symbol areas (3,4), which method includes
associating a control command with each graphic symbol, and
selectively illuminating a sub-set of the symbol areas (3,4) in accordance with a mode of operation of a device being controlled, so as to project associated graphic symbols through the respective symbol areas (3,4),
wherein a control command is obtained by detecting selection of an area (2) corresponding to a key by a body, characterised by
obscuring at least the graphic symbols projected through at least one of the symbol areas (3,4) other than those being illuminated.

10. Method of obtaining control commands, including
providing a device (5) having an at least in parts light-transmitting surface (1) and including an apparatus for projecting a number of graphic symbols through respective symbol areas (3,4) of the surface, which apparatus includes
a lighting arrangement (10;16;22) for selectively illuminating symbol areas from within the device through at least one screen (12;17;24) patterned in accordance with a plurality of the graphic symbols,
wherein the at least parts light-transmitting surface includes at least one area (2) corresponding to a key, each area (2) corresponding to a key encompassing at least one of the symbol areas (3,4), which method includes
associating a control command with each graphic symbol, and
selectively illuminating a sub-set of the symbol areas (3,4) in accordance with a mode of operation of a device being controlled, so as to project associated graphic symbols through the respective symbol areas (3,4),
wherein a control command is obtained by detecting selection of an area (2) corresponding to a key by a body, characterised by
obscuring at least the graphic symbols projected through at least one of the symbol areas (3,4) other than those being illuminated, including the use of a device (5) according to claim 1.

11. Electronic appliance, including a device (5) having an at least in parts light-transmitting surface (1) and including an apparatus for projecting a number of graphic symbols through respective symbol areas (3,4) of the surface (1), which apparatus includes
a lighting arrangement (10;16;22) for selectively illuminating symbol areas (3,4) from within the device through at least one screen (12;17;24) patterned in accordance with a plurality of the graphic symbols,
wherein the at least in parts light-transmitting surface (1) includes at least one area (2) corresponding to a key, each area (2) corresponding to a key encompassing at least one of the symbol areas (3,4), wherein the appliance is configured to execute a method according to claim 9.
